(19) United States
(12) Patent Application Publication
(10) Pub. No.: US 2005/0031032 A1
(43) Pub. Date: Feb. 10, 2005

(54) Method of buffer management in video encoder

(75) Inventors: Chih-Chiang Shen, Taipei (TW); Mei-Chen Yeh, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/912,238

(22) Filed: Aug. 6, 2004

(30) Foreign Application Priority Data
Aug. 8, 2003 (TW) 92121920

(51) Int. Cl. H04N 7/12

(52) U.S. Cl. 375/240.01; 348/419.1; 375/240.12

(57) ABSTRACT

A method for buffer management in a video encoder is provided. When a possibility of buffer overflow is higher, a filter function is enabled in an I picture and a not coded function is enabled in a P or B picture. Furthermore, when the fullness of buffer reaches a predetermine threshold, the filter function is enabled in the I picture and a skip function is directly enabled in the P or B picture.

This application claims the benefit of Taiwan application Serial No. 92121920, filed Aug. 8, 2003, the subject matter of which is incorporated herein by reference.

### BACKGROUND OF THE INVENTION

1. Field of the Invention

The invention relates in general to the video encoder, and more particularly to a method for buffer management in a video encoder.

2. Description of the Related Art

FIG. 1 is a schematic illustration showing a conventional video encoder. In general, after pictures 10 have been sequentially inputted to a video encoder 100, the video encoder divides these pictures into a plurality of GOPs (Groups Of Picture). The pictures in each GOP is further divided into the I pictures (Intra Pictures), P pictures (Predictive Pictures), or B pictures (Bidirectionally Predictive Pictures). In the picture encoding process of the I pictures, a function of DCT (Discrete Cosine Transfer) 20 and a function of quantization (Q) 30 are enabled. Thereafter, the picture encoding process of the I picture may be finished, and the encoded data of the I picture is outputted to the buffer 200. Before the picture encoding processes of the B picture and the P picture, functions of IQ (Inverse Quantization) 40, IDCT (Inverse Discrete Cosine Transfer) 50, and MC (Motion Compensation) 60 are enabled for decoding a reference picture. In the picture encoding process of the B pictures and the P pictures, one of the B pictures or P pictures together with the decoded reference picture are input to DCT 20 and Q 30. Thereafter, the picture encoding process of the B picture or P picture may be finished, and the encoded data of the B picture or P picture is outputted to the buffer 200.

According to MPEG (Moving Picture Expert Group) specification, each picture is divided into a plurality of blocks during the picture encoding process, and the DCTs are sequentially enabled according to the similarity between the blocks. In brief, the block is the basic unit for picture encoding process. During the picture encoding process, the picture encoding of the I picture is directly encoded by DCT 20 and Q 30 to serve as the reference picture for the picture encoding process of other pictures. The P picture is generated through the unidirectional reference. That is, the P picture is encoded according to the reference picture (I picture). It means that the encoded P picture is based on the reference picture (I picture) and their difference between the two pictures. Similarly, the B picture is generated through the bidirectional reference. That is, the picture encoding process of the B picture is encoded according to the front and rear reference pictures (I and P pictures or P and P pictures). Thus, in terms of the distortion level after each picture compression with respect to the image quality, the severe level of the I picture is the greatest, that of the P picture is the secondary, and that of the B picture is the smallest.

Furthermore, after the picture encoding process of the video encoder 100 has been finished, the encoded data after the picture encoding process is stored in the buffer 200. Because the quantities of the encoded data of these pictures after the picture encoding process are not totally the same, the data has to be temporarily stored in the buffer 200, and the buffer 200 outputs the encoded data with a constant data transmission rate. In general, the buffer 200 is a memory.

Because the encoded data quantity inputted into the buffer 200 is uncertain and the buffer 200 has to output with the constant data transmission rate, it is possible that the buffer 200 does not have enough space for storing the inputted encoded data. Thus, a portion of the encoded data that is to be inputted to the buffer 200 may be discarded owing to the buffer overflow. However, if the discarded encoded data is the I picture, the subsequent picture decoding process of the P picture or B picture cannot be performed. This is because the reference picture (I picture) for the P picture or B picture has been discarded during the picture encoding process. Hence, the management for the buffer 200 is an important factor during the MPEG picture encoding process, and it is an important subject for all the researcher to design a buffer monitor unit, in which all the encoded data outputted by the video encoder may be smoothly stored to the buffer 200 without the buffer overflow.

### SUMMARY OF THE INVENTION

It is therefore an object of the invention to provide a buffer management method capable of preventing the buffer overflow in a video encoder.

The invention achieves the above-identified object by providing a buffer management method for a video encoder. The method includes the steps of: judging a storage condition of a buffer; enabling a picture encoding process with a filter function to an I picture and a picture encoding process with a not coded function to a P picture and a B picture when the storage condition approximates an overflow condition; and enabling the picture encoding process with the filter function to the I picture and the picture encoding process with a skip function to the P and B pictures when the storage condition only has a specific capacity left.

The invention also achieves the above-identified object by providing a buffer management method for a video encoder. The method includes the steps of: judging a storage condition of a buffer; enabling a picture encoding process with a filter function to an I picture when the storage condition approximates an overflow condition; and enabling a picture encoding process with a not coded function to a P picture and a B picture when the storage condition approximates an overflow condition.

The invention also achieves the above-identified object by providing a buffer management method for a video encoder. The method includes the steps of: judging a storage condition of a buffer; enabling a picture encoding process with a filter function to an I picture when the storage condition only has a first specific capacity left; and enabling a picture encoding process with a skip function to a P picture and a B picture when the storage condition only has a second specific capacity left.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a conventional video encoder.

FIG. 2 is a schematic illustration showing a GOP.

FIG. 3 is a block diagram showing the buffer management in a video encoder of the invention.

FIG. 4 is a flow chart showing a method of buffer management in the video encoder of the invention.

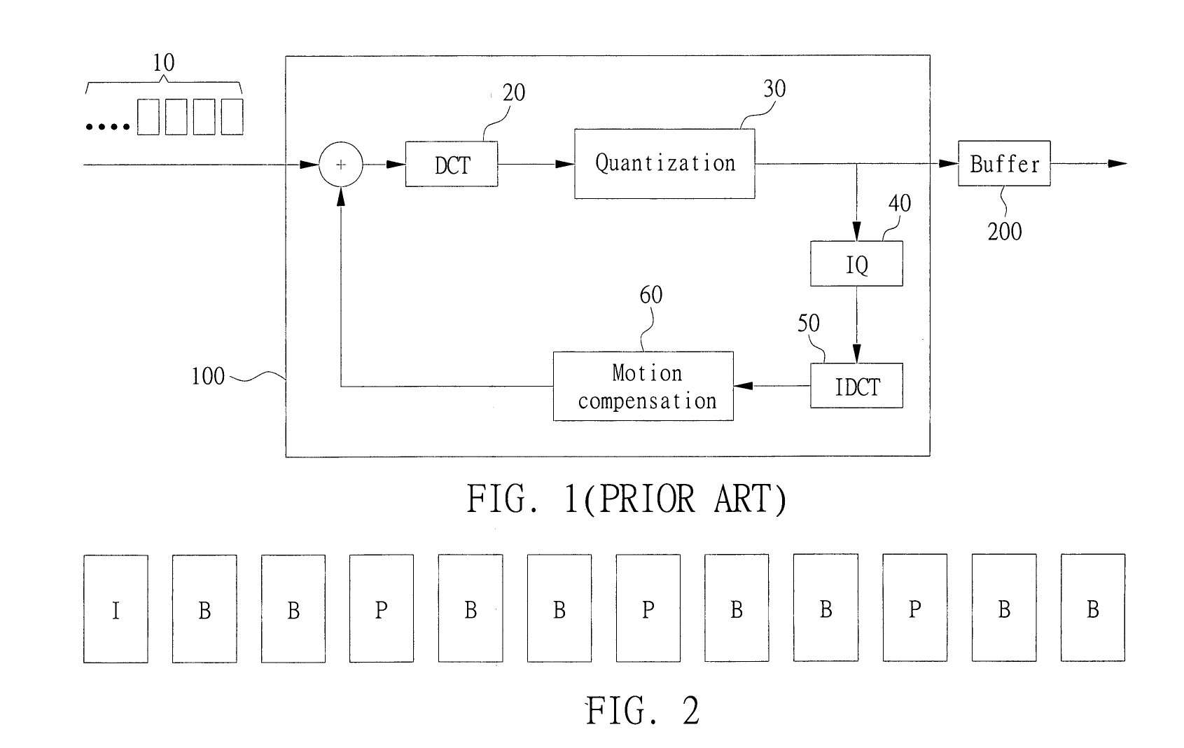

### DETAILED DESCRIPTION OF THE INVENTION

FIG. 2 is a schematic illustration showing a GOP. It is assumed that the data transmission rate (Bit Rate, bits/s) of the buffer is 50 Mbit/s and the frame rate (picture/s) is 30. Thus, the BGOP (Bit In One GOP) of the GOP of 12 pictures in FIG. 2 may be calculated as:
BGOP=12*50M/30=20M (bits).

That is, the encoded data generated after the picture encoding processes for all of the pictures in the GOP have to be within a predetermined range above or below 20 Mbits.

Furthermore, the encoded data quantities of the I, P and B pictures are not totally the same after the picture encoding processes. In general, the encoded data quantity of the I picture is the greatest, the encoded data quantity of the P picture is the secondary, and the encoded data quantity of the B picture is the smallest. That is, B(I)>B(P)>B(B), wherein B(I) represents the encoded data quantity of one I picture, B(P) represents the encoded data quantity of one P picture, and B(B) represents the encoded data quantity of one B picture.

Next, the activity is defined. The activity of the I picture is represented by Activity(I) defined as Activity(I)=σ|pᵢ-pₘₑₐₙ|, which is the sum of differences between all the pixel values in the I picture and the pixel average of the I picture. The activities of the P picture and the B picture are represented by Activity(P) and Activity(B), each of which is defined as Activity(P or B)=σ|pᵢ-p_{ref}|, and is the sum of differences between all the pixel values in the P or B pictures and the corresponding pixel values in the reference picture. That is, the activity may be calculated as long as one I picture is provided, and the activity of the P or B picture cannot be calculated until the reference picture is added. In general, the activity value of the I picture is the maximum, that of the P picture is the secondary, and that of the B picture is the minimum.

During the video encoding process, the ACRs (Activities to Complexity ratio) for the I, P, and B pictures are respectively defined as ACR(I), ACR(P), and ACR(B). In general, ACR(I), ACR(P), and ACR(B) may be held around a stable value with a little variation during the video encoding process. Thus, the complexity of each picture may be calculated according to the activity and ACR after the activity of each picture has been calculated.
C_{I}=Activity(I)/ACR(I)
C_{P}=Activity(P)/ACR(P)
C_{B}=Activity(B)/ACR(B)

The encoded data quantities (B(I), B(P), B(B)) after the picture encoding process is enabled in each picture may be estimated according to the complexity. That is,
B(I)=B_{GOP}*(N_{I}*C_{I})/(N_{I}*C_{I}+N_{P}*C_{P}+N_{B}*C_{B})
B(P)=B_{GOP}*(N_{P}*C_{P})/(N_{I}*C_{I}+N_{P}*C_{P}+N_{B}*C_{B})
B(B)=B_{GOP}*(N_{B}*C_{B})/(N_{I}*C_{I}+N_{P}*C_{P}+N_{B}*C_{B}),
wherein N_{I}, N_{P}, N_{B} represent the total numbers of the I, P and B pictures in one GOP, respectively. In other words, the quantity of each encoded pictures in a GOP can be easily estimate by the above equations.

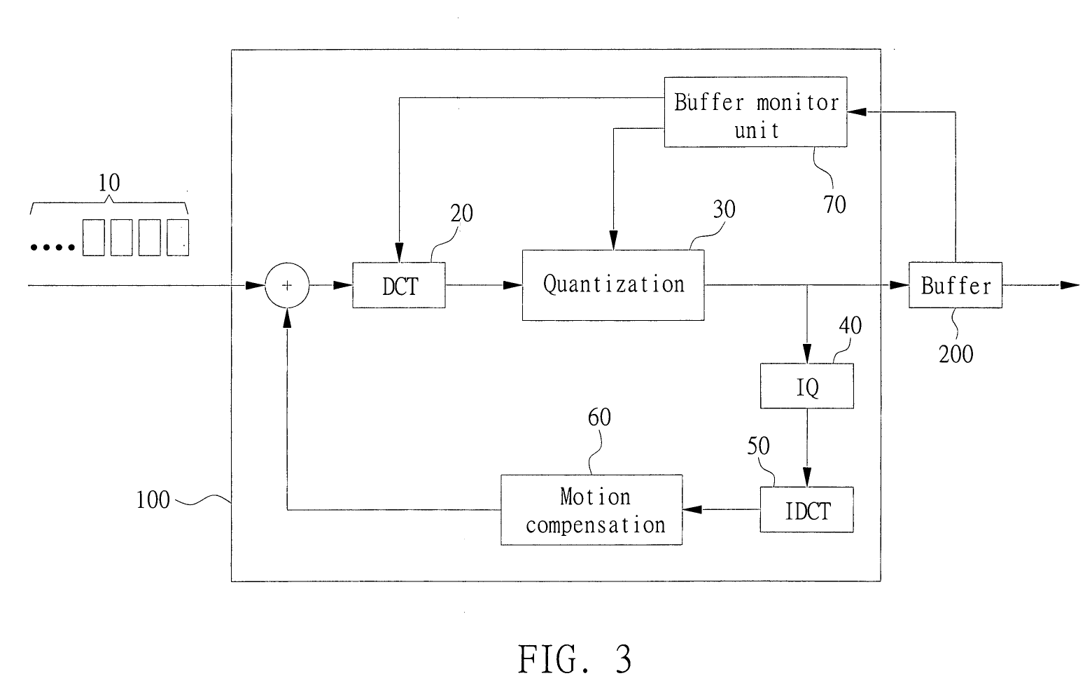

FIG. 3 is a block diagram showing the buffer management in a video encoder of the invention. A buffer monitor unit 70, which changes the control of the picture encoding process according to the storage state in the buffer, is added to the video encoder 100. For example, the quantization function of the video encoder is enabled according to a quantization amplitude, and the encoded data quantity may be changed as the quantization amplitude is changed. In brief, using the buffer monitor unit 70 to increase the quantization amplitude may reduce the encoded data quantity, and reducing the quantization amplitude may increase the encoded data quantity.

Thus, when the encoded data of each picture is outputted to the buffer, the buffer monitor unit 70 may dynamically adjust the quantization amplitude by comparing the estimated encoded data quantities (B(I), B(P), B(B)) with the real encoded data quantities (B(Iᵣₑₐₗ), B(Pᵣₑₐₗ), B(Bᵣₑₐₗ)) such that the sum of the encoded data quantities of all pictures meets the sum of the estimated encoded data quantities.

Furthermore, when the buffer approximates the overflow state, the buffer monitor unit 70 has to judge that the video encoder is now processing which kind of picture. For example, because the encoded data after the picture encoding process may be estimated before the picture encoding process is performed, the first control mechanism has to be enabled when the two following conditions are established.
(1) B(Iᵣₑₐₗ)>B(I)*(total_bik-remain_blk)/total_blk B(Pᵣₑₐₗ)>B(P)*(total_blk-remain_blk)/total_blk B(Bᵣₑₐₗ)>B(B)*(total_blk-remain_blk)/total_blk

The block is the basic unit for picture encoding process. Taking the I picture as an example, when the I picture is being enabled the picture encoding process, the first condition is established at any time instant if the encoded data quantity B(Iᵣₑₐₗ) of the picture that is actually generated is greater than the estimated encoded data quantity. The total_blk is the total number of the divided blocks in the picture, and the remain_blk is the total number of the blocks that the encoding process is not enabled.
(2) buffer's remaining space<B(I)*(remain_blk/total_blk) buffer's remaining space<B(P)*(remain_blk/total_blk) buffer's remaining space<B(B)*(remain_blk/total_blk)

Taking the I picture as an example, the second condition is established when the picture encoding process of the I picture is being enabled and the buffer's remaining space is smaller than the estimated remaining encoded data quantity of the I picture.

When the first and second conditions are established, the first control mechanism is enabled. That is, if the I picture is being enabled the picture encoding process, the I picture is filtered and then stored to the buffer. If the P or B picture is being enabled the picture encoding process, the not coded (Not_Coded) function is enabled to the P or B picture and then the P or B picture is stored to the buffer. The so-called filter function is to store the important coefficients of the encoded data of the I picture to the buffer, and the unimportant coefficients are not stored to the buffer. The so-called not coded function is to disable the encoding function or directly skip the residuals after the motion compensation of the remaining block, and to directly store the blocks that have been encoded. Thus, it is possible to effectively prevent the buffer from overflowing.

Furthermore, when the buffer has reached the 95% saturation condition, the buffer monitor unit 70 has to enable the second control mechanism, which enables a filter function or a skip function according to the currently processing picture. That is, when the buffer has reached the 95% saturation condition, the filter function is filtered as the processed picture is the I picture, and the skip function is enabled as the processed picture is the P or B picture. Because the I picture may be the reference picture for the P picture and the B picture, the encoded data quantity of the I picture may be effectively reduced and the buffer overflow may be avoided after the filter function of the I picture is enabled and then the data is stored to the buffer. Furthermore, because the distortions of the P picture and the B picture are not important to the whole video, the P or B picture is not enabled the picture encoding function and directly skipped to prevent the buffer overflow when the buffer has reached the 95% saturation condition.

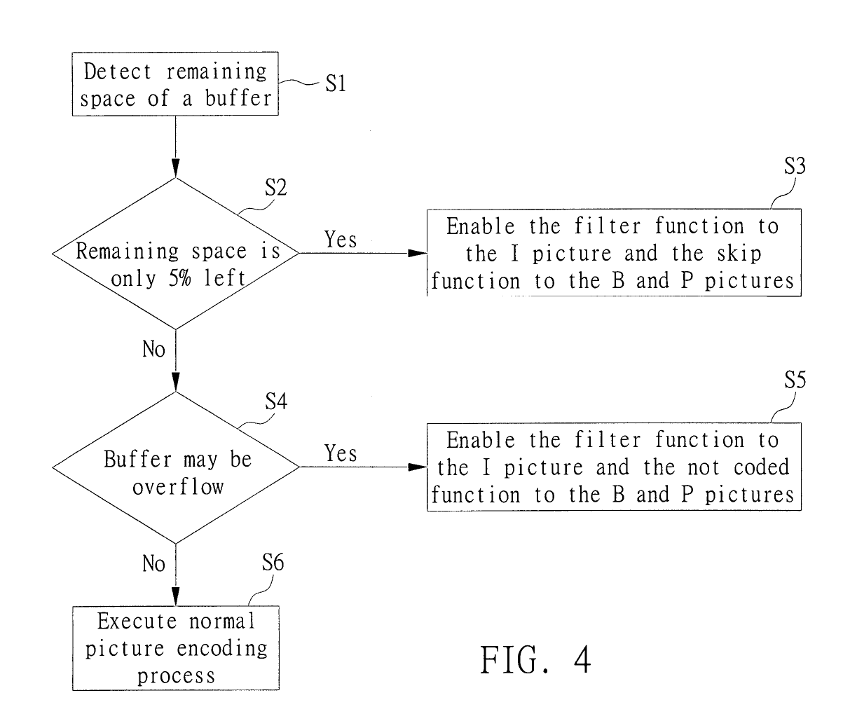

FIG. 4 is a flow chart showing a method of buffer management in the video encoder of the invention. As shown in FIG. 4, the method includes the following steps.

Step S1 is to detect the remaining space of the buffer.

Step S2 is to judge whether or not the remaining space is only 5%. If yes, step S3 is enabled; if not, step S4 is enabled.

Step S3 is to enable the filter function to the I picture, and the skip functions to the P and B pictures.

Step S4 is to judge whether or not the buffer overflow occurs. If yes, step S5 is enabled; if not, step S6 is enabled.

Step S5 is to enable the filter function to the I picture, and the not coded functions to the P and B pictures.

Step S6 is to execute the normal picture encoding process.

The invention discloses two control mechanisms for monitoring the storage condition of the buffer. When the first control mechanism is established, it represents that the buffer may have the overflow condition occurred. Thus, if the picture for picture encoding is the I picture, the filter function is enabled. If the picture for picture encoding is the P or B picture, the not coded function is enabled. Furthermore, when the second mechanism is established, it represents that the buffer has approximated the overflow condition. Thus, if the picture for picture encoding is the I picture, the filter function is enabled. If the picture for picture encoding is the P or B picture, the skip function is directly enabled.

Consequently, the advantage of the invention is to provide a buffer management method in a video encoder, in which the buffer monitor unit is used to monitor the buffer condition, various pictures are selectively filtered, and the remaining pictures are not coded and skipped so that the buffer overflow condition may be effectively avoided.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A buffer management method for a video encoder, comprising the steps of:
judging a storage condition of a buffer;
enabling a picture encoding process with a filter function to an I picture and a picture encoding process with a not coded function to a P picture and a B picture when the storage condition approximates an overflow condition; and
enabling the picture encoding process with the filter function to the I picture and the picture encoding process with a skip function to the P and B pictures when the storage condition only has a specific capacity left.

2. The method according to claim 1, wherein the step of judging the overflow condition of the buffer is made according to that a real encoded data quantity of a specific picture, when the picture encoding process is enabled, is larger than an estimated encoded data quantity, and an estimated remaining encoded data quantity is larger than a remaining space of the buffer.

3. A buffer management method for a video encoder, comprising the steps of:
judging a storage condition of a buffer;
enabling a picture encoding process with a filter function to an I picture when the storage condition approximates an overflow condition; and
enabling a picture encoding process with a not coded function to a P picture and a B picture when the storage condition approximates the overflow condition.

4. The method according to claim 3, wherein the step of judging the overflow condition of the buffer is made according to that a real encoded data quantity of a specific picture, when the picture encoding process is enabled, is larger than an estimated encoded data quantity, and an estimated remaining encoded data quantity is larger than a remaining space of the buffer.

5. A buffer management method for a video encoder, comprising the steps of:
judging a storage condition of a buffer;
enabling a picture encoding process with a filter function to an I picture when the storage condition implies a first specific capacity left; and
enabling a picture encoding process with a skip function to a P picture and a B picture when the storage condition implies a second specific capacity left.
